(19) United States
(12) Patent Application Publication
(10) Pub. No.: US 2002/0031280 A1
(43) Pub. Date: Mar. 14, 2002

(54) Complex image processing device with serial bus switching ability

(76) Inventors: Kung-Cho Sheng, Taipei Hsien (TW); Chang-Yung Feng, Taipei City (TW)

Correspondence Address: WINSTON HSU, SF. 389, FU-HO ROAD, YUNGHO CITY, TAIPEI, TW

(21) Appl. No.: 09/682,404

(22) Filed: Aug. 30, 2001

(30) Foreign Application Priority Data
Sep. 14, 2000 (TW) 089118785

(51) Int. Cl. G06K 9/54; G06K 9/60

(52) U.S. Cl. 382/305

(57) ABSTRACT

A complex image processing device, with a serial bus switching ability, is electrically connected to a computer by a serial bus. The device has a housing, an image capturing unit installed inside the housing for generating digital image data from a picture, a memory card reading unit installed inside the housing for reading digital data stored in a memory card, and an electromagnetic mechanical switch installed between the serialbus and the device. The electromagnetic mechanical switch, controlled by a software driver, can switch between the image capturing unit and the memory card.

### BACKGROUND OF INVENTION

1. Field of the Invention

The present invention relates a complex image processing device, and more particularly, to a complex image processing device with a serial bus switching ability achieved by using an electromagnetic mechanical switch.

2. Description of the Prior Art

Please refer to FIG. 1, which is a block diagram of a prior art image processing device 20. The image processing device 20 is electrically connected to a universal serial bus (USB) port 12 of a computer 10 via a serial bus cable 16. The image processing device 20 comprises an image capturing unit 22 for converting images into digital data, a memory card reading unit 26 for reading digital data from a memory card 27, and a hub 24 electrically connected between the serial bus cable 16 and the image processing device 20. The image processing device 20 processes signal transmission of the image capturing unit 22, the memory card reading unit 26, and the computer 10, so that the computer 10 can control the image capturing unit 22 and the memory card reading unit 26 of the image processing device 20 through the serial bus cable 16.

In general, a maximum power provided by the universal serial bus (USB) port 12 via the serial bus cable to the image processing device is 500 mA*5V, with the power consumption of the hub 24 equal to about 150 mA*5V. If the image processing device 20 connects to the USB port 12 with the hub 24, the power consumption of the image processing device 20 is 350 mA*5V, meaning that the remaining power equals 350 mA*5V(500−150=350 mA*5V). When using the image processing device 20, the hub 24 is usually connected to an external power source, so the hub 24 does not consume the power supplied through the USB port 12. However, additional external power sources require additional cables, thus increasing a complexity of wiring, and making use inconvenient for users.

### SUMMARY OF INVENTION

It is therefore a primary objective of the present invention to provide a complex image processing device with a serial bus switching ability achieved by using an electromagnetic mechanical switch.

According to the claimed invention, the image processing device uses an electromagnetic mechanical switch powered by a universal serial bus (USB) of a computer. The electromagnetic mechanical switch enables the computer to switch between a capturing unit and a memory card reading unit via a serial bus cable, such that a user can store digital data in a memory card.

It is an advantage of the present invention that the power of the electromagnetic mechanical switch is provided by the universal serial bus, so that the electromagnetic mechanical switch does not require an external power source. Since the hardware structure is less complicated than the hardware structure of a hub, manufacturing expenses of the image processing device are significantly reduced.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a block diagram of a prior art image processing device.

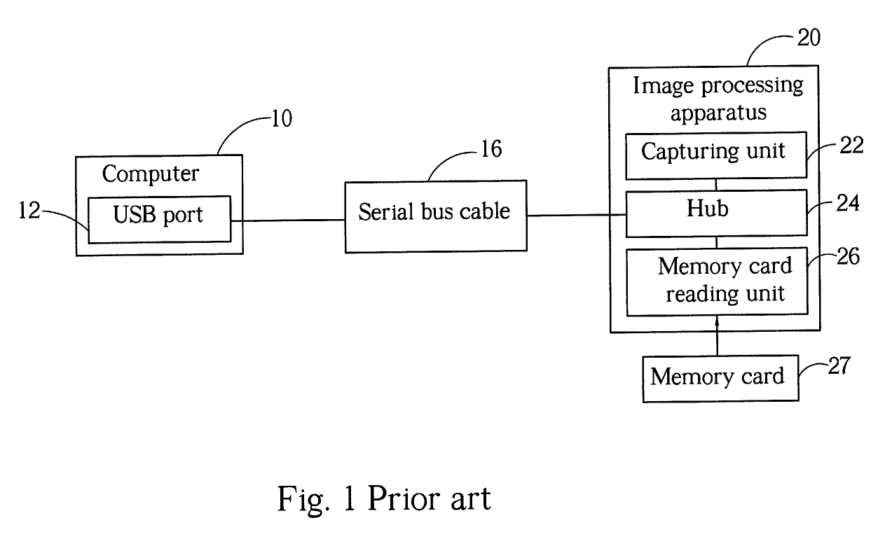

FIG. 2 is a diagram of the present invention image processing device electrically connected to a computer.

FIG. 3 is a block diagram of the image processing device shown in FIG. 2 electrically connected to a computer.

FIG. 4 is a diagram of a switch circuit of the image processing device shown in FIG. 2.

### DETAILED DESCRIPTION

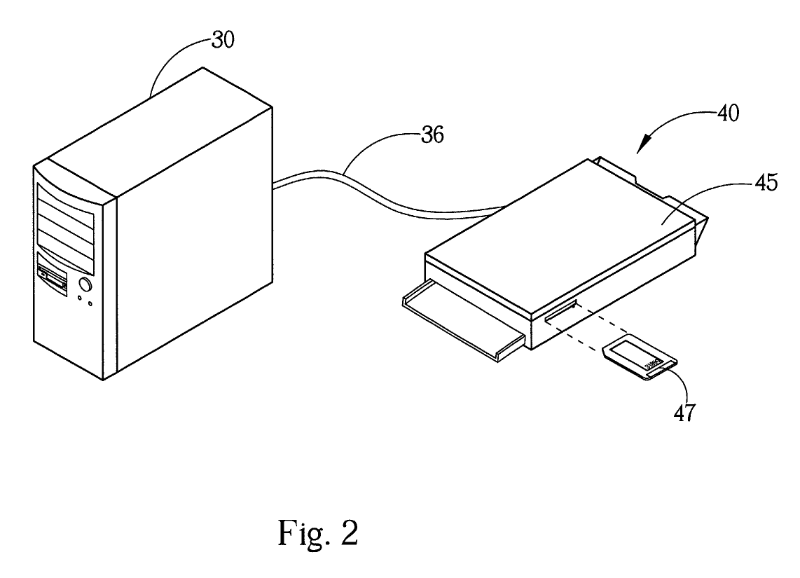

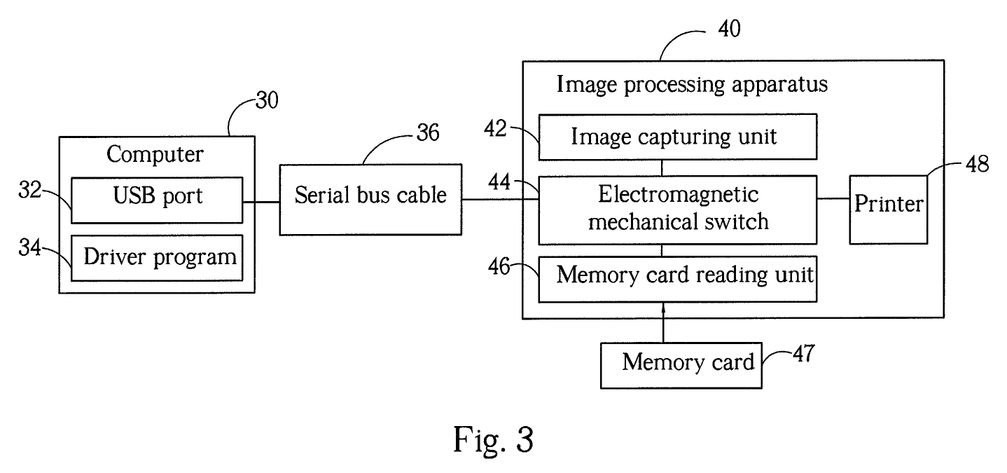

Please refer to FIG. 2 and FIG. 3. FIG. 2 is a diagram of the present invention image processing device 40 electrically connected to a computer 30. FIG. 3 is a block diagram of the image processing device 40 shown in FIG. 2 electrically connected to the computer 30. The image processing device 40 is electrically connected to the computer 30 via a serial bus cable 36. The image processing device 40 has a housing(not shown), an image capturing unit 42 installed inside the housing (not shown) for generating digital image data from a picture. A memory card reading unit 46 is installed inside the housing(not shown) for reading digital data stored in a memory card 47, and an electromagnetic mechanical switch 44 is electrically connected between the serial bus cable 36 and the image processing device 40 for switching the computer 30 to the image capturing unit 42 or the memory card reading unit 46 via the serial bus cable 36. The serial bus 32 is a universal serial bus (USB), the image capturing unit 42 is a scanner, and the memory card reading unit 46 is a card reader.

A user can switch the electromagnetic mechanical switch 44 manually so the computer 30 switches to the image capturing unit 42 or the memory card reading unit 46 via the serial bus cable 36. When the electromagnetic mechanical switch 44 switches to the image capturing unit 42, the image capturing unit 42 can transmit digital data to the computer 30 via the serial bus cable 36. When the electromagnetic mechanical switch 44 switches to the memory card reading unit 46, the memory card reading unit 46 can transmit digital data to the computer 30 via the serial bus cable 36. The image processing device 40, therefore, switches the serial bus cable 36 to the image capturing unit 42 or the memory card reading unit 46 by using the electromagnetic mechanical switch 44. Additionally, when the electromagnetic mechanical switch 44 switches to the image capturing unit 42, the serial bus cable 36 is not electrically connected to the memory card reading unit 46, and likewise when the electromagnetic mechanical switch 44 switches to the image capturing unit 42, the serial bus cable 36 is not electrically connected to the memory card reading unit 46. The serial bus cable 36 is only electrically connected to either the image capturing unit 42 or the memory card reading unit 46 at any one time. The serial bus cable 36 can transmit the signals and data between the computer 30 and the image processing device 40 via two signal ports. Also, power is supplied by the serial bus 32 to the image processing device 40 via two power pins and, for this reason, when the image processing device 40 is in operation, only one device, either the image capturing unit 42 or the memory card reading unit 46, consumes power supplied via the serial bus 32 to the image processing device 40 at any one time.

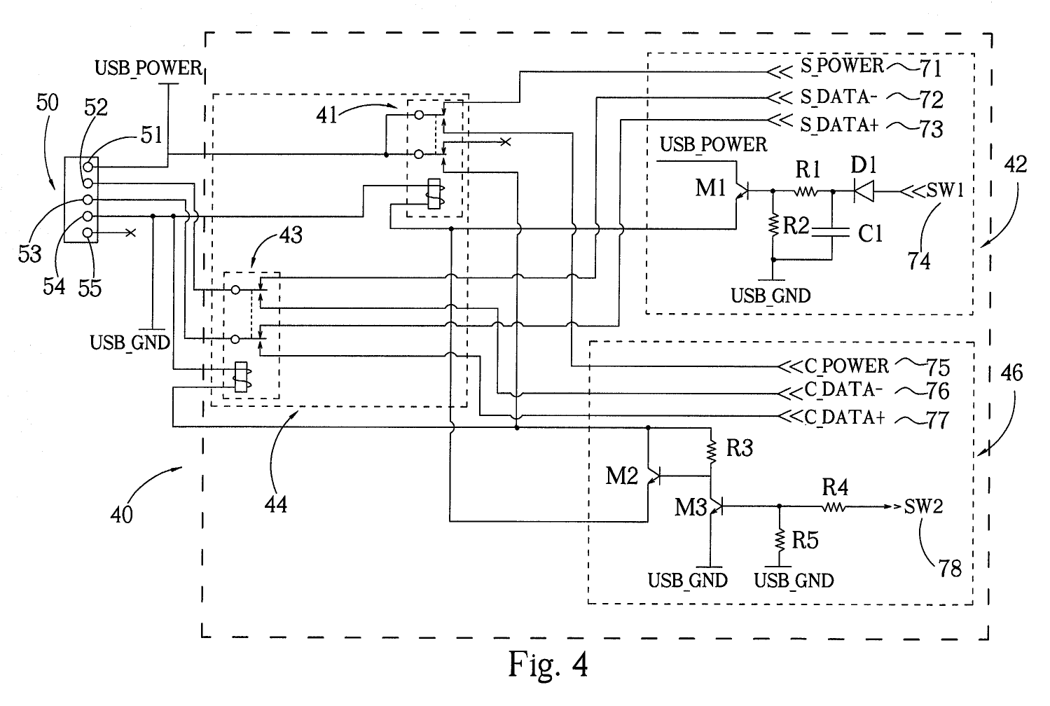

Please refer to FIG. 4, which is a circuit diagram of the switch 44 of the image processing device 40 shown in FIG. 2. The serial bus cable 36 has a connected port 50 for connecting to the image processing device 40. The connected port 50 has a first power pin 51 electrically connected to USB_POWER of the universal serial bus 32, a first data pin 52 electrically connected to a signal port of the universal serial bus 32, a second data pin 53 electrically connected to another signal port of the universal serial bus 32, a second power pin 54 electrically connected to USB_GND of the universal serial bus 32, and a backup pin 55. The electromagnetic mechanical switch 44 has a first relay 41 for switching the first power pin 51 to the power port (S_POWER) 71 of the image capturing unit 42 or the power port (C_POWER) 75 of the memory card reading unit 46. A second relay 43 switches the first data pin 52 to the first signal port (S_DATA −) 72 of the image capturing unit 42 or the first signal port (C_DATA −) 76 of the memory card reading unit 46, and switches the second data pin 53 to the second signal port (S_DATA +) 73 of the image capturing unit 42 or the second signal port (C_DATA +) 77 of the memory card reading unit 46. The image capturing unit 42 has a transistor M1, two resistances R1, R2, and a capacitance C1. The memory card reading unit 46 has two transistors M2, M3, and three resistances R3, R4, R5.

The following is a description of how the electromagnetic switch functions. A positive voltage is entered at the first switch signal port (SW1) 74, causing the electromagnetic mechanical switch 44 to switch to the memory card reading unit 46 from the image capturing unit 42. Alternatively, if a positive voltage is entered at the second switch signal port (SW2) 78, the electromagnetic mechanical switch 44 switches to the image capturing unit 42 from the memory card reading unit 46.

When the first switch signal port 74 of the image capturing unit 42 enters a positive voltage, the transistor M1 supplies a voltage to the first relay 41 making the first power pin 51 switch to the power port (C_POWER) 75 of the memory card reading unit 46 and a collector of the transistor M2. When the USB 32 supplies the voltage to the collector of the transistor M2 via the first power pin 51, the transistor M2 is switched on, so that a voltage is supplied to the second relay 43. The result is that the first data pin 52 switches to the first signal port (C_DATA −) 76 of the memory card reading unit 46 from the first signal port (S_DATA −) 72 of the image capturing unit 42, and the second data pin 53 switches to the second signal port (C_DATA+ 77 of the memory card reading unit 46 from the second signal port (S_DATA−+ 73 of the image capturing unit 42. Furthermore, while a voltage is supplied, the first power pin 51 continues to supply voltage to the collector of the transistor M2, so that as long as this voltage is supplied, the first power pin 51 is electrically connected to the power port 75 of the memory card reading unit 46. The first signal cable 52 is electrically connected to the first signal cable 76 of the memory card reading unit 46, and the second signal cable 53 is electrically connected to the second signal cable 77 of the memory card reading unit 46. The electromagnetic mechanical switch 44 switches to the memory card reading unit 46 from the image capturing unit 42 when the first switch signal port 74 goes to a positive voltage.

When the transistor M2 is connected and a voltage is supplied to the relays 41, 43, adding a positive voltage to the second switch signal port 78 turns on the transistor M3 and the transistor M2. The result is that no power is supplied to the first relay 41 or the second relay 43, and the first power cable 51 switches to the power port 71 from the power port 75, the first signal cable 52 switches to the first signal cable 72 from the first signal cable 76, and the second signal cable 53 switches to the second signal cable 73 from the second signal cable 77. To summarize, the electromagnetic mechanical switch 44 can switch between the memory card reading unit 46 and the image capturing unit 42 when the first switch signal port 74 or the second switch signal port 78 goes to a positive voltage.

As shown in FIG. 3, the computer 30 has a driver 34 to control the image processing device 40. The driver 34 removes the need for the device to be manually operated, thereby increasing efficiency and usability of the image processing device 40. When the user wishes to capture images from the image capturing unit 42, the driver 34 switches the electromagnetic mechanical switch 44 to the image capturing unit 42 automatically. When the user wishes to read digital data from the memory card 47, the driver 34 switches the electromagnetic mechanical switch 44 to the memory card reading unit 46 automatically. The memory card reading unit 46 also has the ability of writing digital data into the memory card 47. If the user wishes to capture an image from the image capturing unit and store the image into the memory card 47, the driver 34 switches the electromagnetic mechanical switch 44 to the image capturing unit 42 to capture data. After that, the driver 34 switches the electromagnetic mechanical switch 44 to the memory card reading unit 46 again to store the image into the memory 47.

If the image processing device 40 further has a printer 48, then the computer 30 does not need to use up another peripheral connecting port to connect the printer 48 to allow the computer 30 to print. As shown in FIG. 3, the printer 48 can be electrically connected to the electromagnetic mechanical switch 44, and the electromagnetic mechanical switch 44 can switch to the printer 48. When the user wants to print an image from the printer 48, the electromagnetic mechanical switch 44 switches to the printer 48 to print either manually or automatically by the driver 34. In this way, the computer 30 has three functions: capturing digital images, reading/writing digital images to a memory card, and printing digital images through a peripheral port. Besides the printer 48, other devices can be electrically connected to the electromagnetic mechanical switch 44 to increase the functionality of the present invention and simplify the wiring of the peripheral devices of the computer 30.

In addition, other serial bus technologies, such as IEEE 1394, can be applied to the present invention, and achieve the same function.

In contrast to the prior art image processing device 20, the present invention image processing device 40 replaces the prior art hub 24 by the electromagnetic mechanical switch 44 to achieve the switching ability of the serial bus. Since the structure of the electromagnetic mechanical switch 44 is less complicated than that of the hub 24, the present invention is not only stable, but also inexpensive. Also, the power consumption of the electromagnetic mechanical switch 44 is low, so the present invention does not require any external power source. The image capturing unit 42 and the memory card reading unit 46 still can use the power supplied by the serial bus.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image processing device electrically connected to a computer with a serial bus cable, the device comprising:
a housing;
an image capturing unit installed inside the housing for generating digital image data from a picture;
a memory card reading unit installed inside the housing for reading digital data stored in a memory card; and
an electromagnetic mechanical switch for establishing an electrical connection between the serial bus cable and the image capturing unit or the memory card reading unit, with power of the electromagnetic mechanical switch supplied by the serial bus cable;
wherein when the electromagnetic mechanical switch switches the connection over to the image capturing unit, the image capturing unit is capable of transmitting digital image data to and receive data from the computer; and
when the electromagnetic mechanical switch switches the connection over to the memory card reading unit, the memory card reading unit is capable of transmitting digital data to and receive data from the computer.

2. The device of claim 1 wherein when the electromagnetic mechanical switch switches the connection over to the image capturing unit, the serial bus cable is electrically disconnected from the memory card reading unit, and when the electromagnetic mechanical switch switches the connection over to the memory card reading unit, the serial bus cable is electrically disconnected from the image capturing unit.

3. The device of claim 1 wherein the computer further comprises a driver program for controlling the device; when a user wants to use the image capturing unit to retrieve digital image data, the electromagnetic mechanical switch switches the connection over to the image capturing unit; and when the user wants to use the memory card reading unit to retrieve digital data stored in the memory card, the electromagnetic mechanical switch switches the connection over to the memory card reading unit.

4. The device of claim 1 wherein the electromagnetic mechanical switch is manually controlled.

5. The device of claim 1 wherein the memory card reading unit is capable of storing digital data in the memory card.

6. The device of claim 5 wherein the computer further comprises a driver program for controlling the device; and when a user wants to first retrieve the digital image data from the image capturing unit and then store the digital image data in the memory card, the electromagnetic mechanical switch switches the connection first to the image capturing unit and then over to the memory card reading unit so that the digital image data can be stored in the memory card.

7. The device of claim 1 wherein the serial bus cable is a USB port cable or an IEEE 1394 cable.

8. The device of claim 1 wherein the serial bus cable comprises two power lines and two data lines, while the electromagnetic mechanical switch comprises two relays for switching the two power lines and the two data lines.

9. The device of claim 1 wherein the image capturing unit is a scanner.

10. The device of claim 1 further comprising a printer electrically connected to the electromagnetic mechanical switch, with the electromagnetic mechanical switch capable of switching the electrical connection over to the printer so that the printer electrically connects to the computer via the serial bus cable.

11. The device of claim 1 wherein when no power is supplied to the electromagnetic mechanical switch, the electromagnetic mechanical switch will switch its connection to the image capturing unit; and when power is supplied to the electromagnetic mechanical switch, the electromagnetic mechanical switch will switch its connection to the memory card reading unit.
